(19) United States
(12) Patent Application Publication
(10) Pub. No.: US 2021/0278335 A1
(43) Pub. Date: Sep. 9, 2021

(54) OPTICAL PARTICLE ANALYZER

(71) Applicant: EI Spectra, LLC

(72) Inventor: Harold E. Ayliffe, Ketchum, ID (US)

(21) Appl. No.: 16/323,401

(22) PCT Filed: Aug. 7, 2017
(86) PCT No.: PCT/US17/45766

§ 371 Date: Feb. 5, 2019

(51) Int. Cl. G01N 15/14; G01N 15/06; G01N 21/05

(52) U.S. Cl. CPC G01N 15/1459; G01N 15/06; G01N 2015/0065; G01N 2015/0693; G01N 21/05

(57) ABSTRACT

An apparatus includes a body having at least one channel disposed therein configured to permit fluid flow therethrough. A first portion of the at least one channel is configured to permit interrogation of particles carried by a fluid passing therethrough by a sensor device external to the body. The body further has an entry aperture fluidly coupling the at least one channel to ambient and configured to receive the fluid into the at least one channel. The apparatus further includes first and second sensor elements. The first element is positioned to permit detection of flow of the fluid upstream of a second portion of the at least one channel, and the second element is positioned to permit detection of flow of the fluid downstream of the second portion of the at least one channel.

### PRIORITY CLAIM

This Application claims the benefit of U.S. Provisional Application Nos. 62/371,395 filed Aug. 5, 2016; 62/420,394 filed Nov. 10, 2016; and 62/480,305 filed Mar. 31, 2017. All of the aforementioned applications, as well as U.S. Provisional Application No. 62/281,915 filed Jan. 22, 2016, are hereby incorporated by reference in their entireties as if fully set forth herein.

### BRIEF DESCRIPTION OF THE DRAWING FIGURES

FIG. 1 is an exploded top view of a tip assembly according to an embodiment of the present invention;

FIG. 2 is an exploded bottom view of the tip assembly illustrated in FIG. 1;

FIG. 3 is a cross-sectional front view of the tip assembly illustrated in FIG. 1;

FIG. 4 is a top plan view of a microfluidic interrogation apparatus according to an embodiment of the present invention;

FIG. 5 is a top plan view of detail A of the apparatus illustrated in FIG. 4;

FIG. 6 is a cross-sectional view along section B-B of the apparatus illustrated in FIG. 5;

FIG. 7 is a cross-sectional view of detail C of the apparatus illustrated in FIG. 6;

FIG. 8 is a front plan view and cross-sectional view along section D-D of a sample cartridge according to an embodiment of the present invention;

FIG. 9 is a cross-sectional view of the cartridge illustrated in FIG. 8;

FIG. 10 is a front plan view of a sample cartridge according to an alternative embodiment of the present invention;

FIG. 11 is a rear perspective view of the cartridge illustrated in FIG. 10;

FIG. 12 is a cross-sectional view of the cartridge illustrated in FIG. 10;

FIG. 13 is a side perspective view of a microfluidic interrogation apparatus according to an embodiment of the present invention;

FIG. 14 is a top plan partial cross-sectional view of the optics layout of and internal to the apparatus illustrated in FIG. 13;

FIG. 15 is a cross-sectional view of detail D of the apparatus illustrated in FIG. 14; and

FIG. 16 is a bottom perspective view of a microfluidic interrogation apparatus according to an embodiment of the present invention.

### DETAILED DESCRIPTION OF THE PREFERRED EMBODIMENT

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be described in the general context of computer-executable instructions, such as program modules, being executed by a processing device having specialized functionality and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a. computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

One or more embodiments of the invention can be utilized as an assay development instrument, and many powerful cell-based assays can easily be optimized and run on such systems. Such functionality may include:

Cell viability assays

Apoptosis assays

Cell surface immuno-labeling

In-Cell Protein Quant

CRISPR/Transfection Optimization Studies

Up to twenty-four plex-bead-based ELISA's using an on-board MPX Relative Quantitation Ap

In-cell Wester Blots

Reactive Oxidation Species Experiments

Calein AM studies

Phagocytosis Analysis

Mito Potential Experiments

An embodiment includes a high quality, glass capillary tube incorporated into a plastic housing to create a high performance consumable flow cell. This embodiment allows multiple tests to be run in each consumable, and for the user to recollect a purified or precious sample from the cartridge reservoir following analysis. In addition to the capillary, each consumable may have three optical detection areas (an embodiment may have only two optical detection areas) to determine the arrival/presence of the sample being tested. The three detectors are used for Start, Stop, and Reservoir Full. The volume within the fluid channel between the Start and Stop detectors is used to calculate the volumetric particle count.

An embodiment includes a high-performing flow cytometer pipette employing a consumable flow cell. An embodiment employs a consumable (i.e., disposable) flow cell in the form of a tip assembly 4 incorporating a microcapillary tube 31 into a plastic body. The tip assembly 4 according to an embodiment may consist of two plastic elements 30, 32 having fluid channels molded within and with capillary tube 31 made of a translucent material such as, for example, glass or plastic. The elements 30, 32 and tube 31 may be bonded together via glue, ultrasonic welding, laser welding, tape, etc. As will be discussed in greater detail herein below, this configuration of tip assembly 4 enables simultaneous optical detection of (1) the single particles of interest (cells, beads, etc.) in a fluid as they are pulled through the capillary tube 31 by a vacuum and (2) the presence of the fluid front as it passes at least two locations (start and stop) for volumetric particle counting.

A pipette instrument 100 according to an embodiment contains a digital board 19, which may include a printed circuit board containing a microprocessor, analog/digital circuitry and a memory, a battery, a display 18, such as a touch sensitive display, a vacuum source 17, such as a pump, and at least one optical detector such as a first PIN diode 8. Pipette 100 further includes a laser 2 and a mirror 10 controlled by a steering assembly 1.

In an embodiment, the beam 9 emitted by laser 2 is aligned to the microcapillary tube 31 in the tip assembly 4 each time a tip is inserted by steering mirror 10 using feedback from an optical detector such as second PIN diode 14.

Once the laser 2 is aligned, the user inserts the tip of the tip assembly 4 into a vial containing a sample and activates the pipette 100 by, for example, pressing an On/Off/Reset button 22. Upon activation, vacuum is generated within the pipette 100 at tip 23, and the sample is pulled up into the tip assembly 4. Once the presence of the fluid is detected, the particle data is counted, collected and stored at least until the fluid stop signal is detected. An embodiment measures one color fluorescence with simultaneous particle size via primary laser wavelength transmittance. The volumetric cell count is possible because the volume of fluid measured between the start and stop locations, in which optional first and second prisms 35a, 35b are respectively located, is known.

The optical start and stop may be determined using one or more photointerrupters 15 In an embodiment, the photointerrupter 15 is an integrated chip that both transmits and receives light. Photointerrupter 15 allows a determination of when fluid reaches specific locations within the tip assembly 4, thereby allowing volumetric particle counts because the volume of the channel (i.e., known-volume channel 33) between the start and stop detectors is known.

As discussed above, tip assembly 4 may have at least one channel 33 with a pre-known volume so the system can perform volumetric cell/particle counts. An embodiment includes two sections/channels, a ˜50 μL section and a 150 μL section/channel.

An embodiment can determine when the fluid reaches specific locations within the flow cell body to determine “start” and “stop” events that correspond to the known-volume channels described above. An embodiment uses optical photointerrupters to detect the passing of the fluid front. The tip assembly can incorporate geometry within the fluid channel that amplifies the change in the optical signal measured by the photointerrupters when the fluid front wets the surfaces of the amplifying geometry. Specifically, and in an embodiment, a wedge-shape feature, such as a prism, with 45-degree walls will reflect significantly more of the emitted light from the photointerrupters (thereby yielding a high signal from the photointerrupters) compared to when the 45-degree walls become wet (thereby yielding a low signal from the photointerrupters). These wedge-shaped features act to both improve accuracy and reliability of fluid detection within the flow cell. An embodiment could also use changes in electric impedance from electrodes within the flow cell. An embodiment detects a “start”, a “stop 1” event (for the 50 μL channel) and a “stop 2” event at the end of the 150 μL channels (for a total 200 μL counted).

An embodiment can use a steering mirror assembly and PIN photo detector to align the laser to the capillary each time a new flow cell is inserted into the system. The capillary is placed in front of the PIN diode, the laser is turned on, and the mirror is swept back and forth to determine the center of the capillary tube (based on feedback from the PIN diode).

An embodiment can use a PIN diode to measure “side scatter” for the laser light bouncing off the cells/particles and/or a PIN diode to measure particle size via “optical transmittance”. The transmittance channel is the same PIN diode used to align the laser to the capillary tube.

Embodiments may include simple systems that the user manually places the flow cell into, and/or more complex systems that can auto feed the flow cells. Automated systems can be programmed to pull the cell sample directly from multi-well trays (plates) using robotics. In these systems, a 96-well, for example, plate (containing the stained cells or beads) could be placed in the system and a bundle of 96-up flow cells would be added. The system would then automatically analyze each sample and create a file for each sample. These files can be batched as per the user's request.

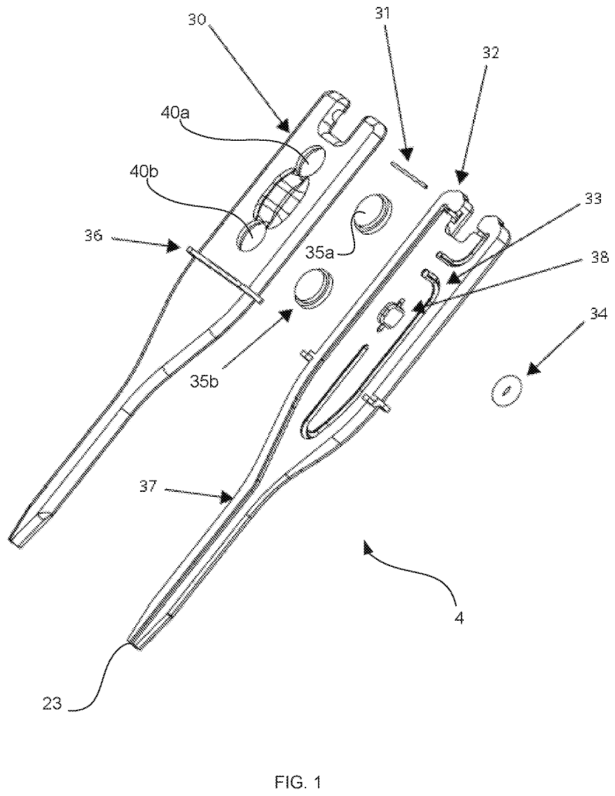

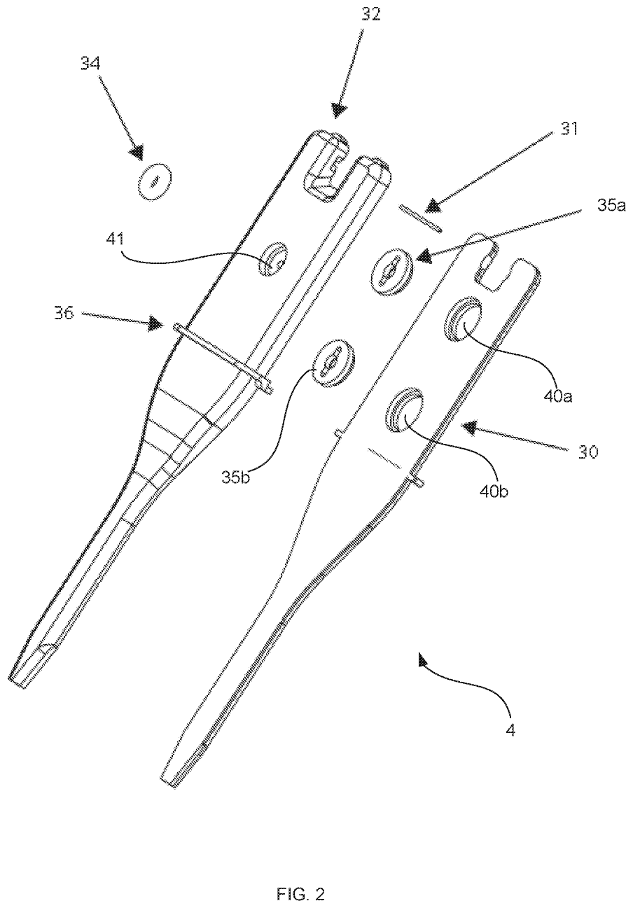

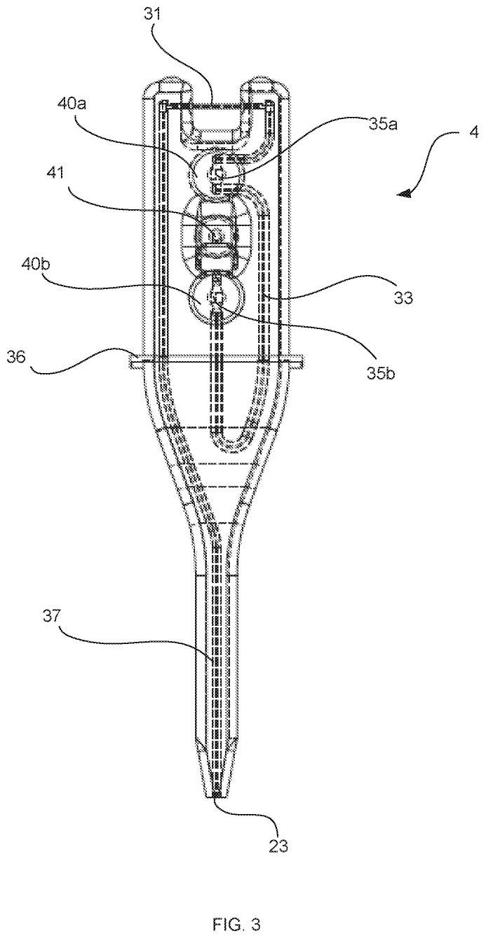

Referring to FIGS. 1-3, and in an embodiment, the tip assembly 4 has an input channel 37 and a known-volume channel 33 of predetermined known volume disposed therein. Each channel 33, 37 is configured to permit fluid flow therethrough. Tip assembly 4 further includes an entry aperture 23 fluidly coupling the input channel 37 to ambient and configured to receive the fluid into the input channel 37. Tip assembly 4 includes a suction aperture 41 fluidly coupling the known-volume channel 33 to ambient. An O-ring 34 is disposed within suction aperture 41 to create a vacuum seal between the tip assembly 4 and an interrogation apparatus such as a pipette instrument 100, as will be discussed in greater detail herein below.

in the illustrated embodiment, microcapillary 31 transmits fluid from one segment of input channel 37 to another segment of input channel. Microcapillary 31 permits interrogation of particles carried by the fluid passing therethrough by a sensor device external to tip assembly 4, as will be discussed in greater detail herein below.

Tip assembly 4 further includes first and second sensor apertures 40a, 40b. Sensor elements, such as first and second prisms 35a, 35b that refract light when wetted by the fluid, are respectively positioned in the first and second sensor apertures 40a, 40b and in the fluid stream to permit detection of flow of the fluid by at least one sensor device external to the tip assembly 4, as will be discussed in greater detail herein below. The first prism 35a is positioned to permit detection of flow of the fluid at an upstream portion of the known-volume channel 33, and the second prism 35b is positioned to permit detection of flow of the fluid at a downstream portion of the known-volume channel. Tip assembly 4 may also include an opaque light dam 36, which can serve to block ambient light from reaching either of the sensor apertures 40a, 40b. An overflow reservoir 38 functions to prevent fluid from leaving the tip assembly 4 after a test is complete.

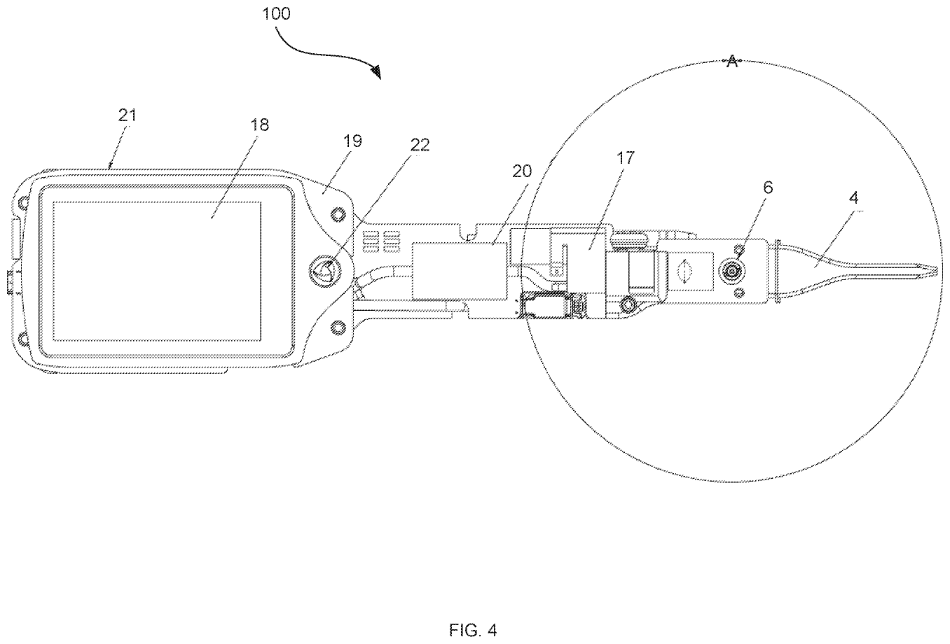

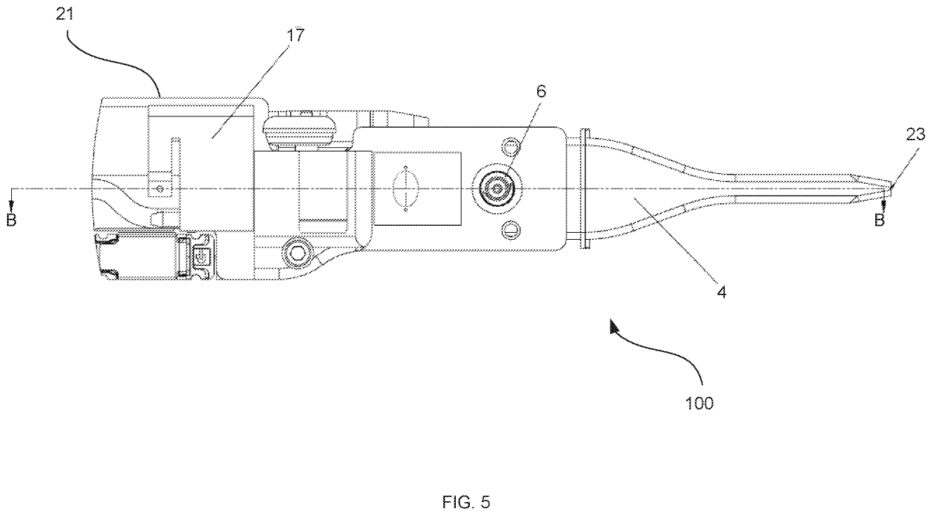

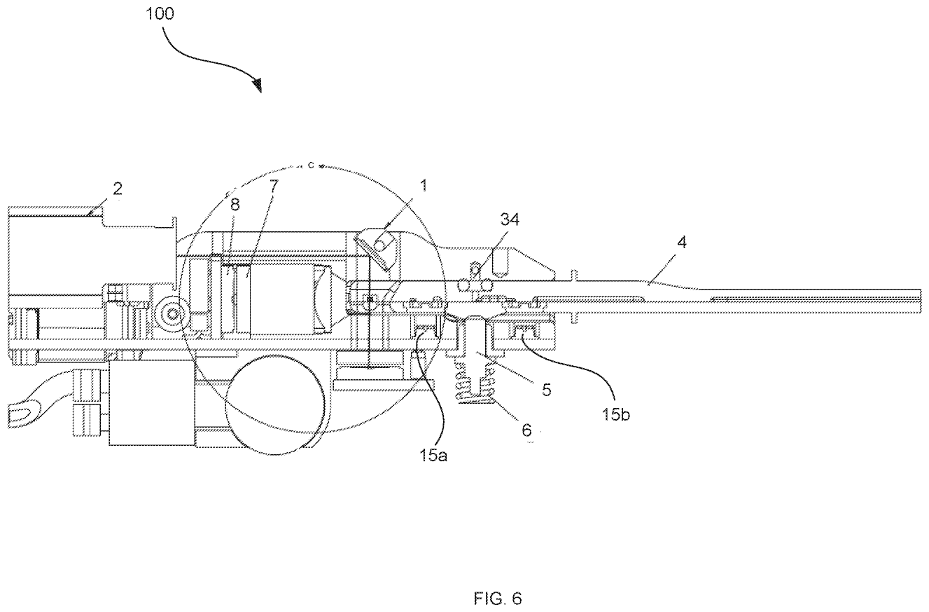

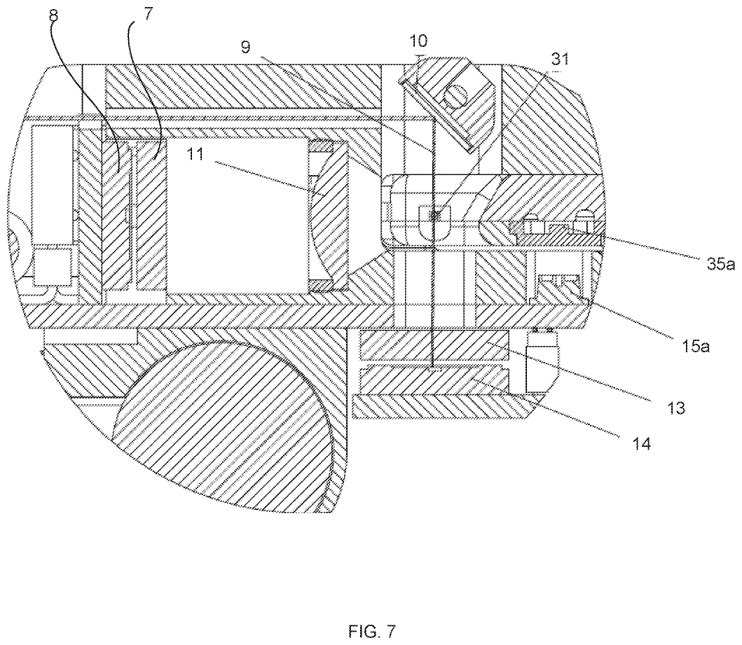

Referring now to FIGS. 4-7, and in an embodiment, a microfluidic interrogation apparatus, such as a pipette instrument 100, includes a housing 21 configured to receive therein tip assembly 4. Instrument 100 is sized sufficiently small in both weight and enclosed volume as to permit a single person, by hand and without tools, to move the entirety of instrument from a first location to a second location. Instrument 100 includes a microfluidic particle detector disposed within the housing 21 and configured to interrogate the microcapillary 31.

The particle detector includes a laser 2, a control surface, such as a mirror 10 attached to a steering assembly 1, configured to direct an illuminating beam 9 emitted by the laser to the microcapillary 31, and at least one optical detector such as at least one of fluorescence PIN diode 8 and PIN diode 14 positioned within a line of sight of the illuminated microcapillary. The particle detector may further include an optical filter 7 to filter out primary excitation laser light thereby enabling PIN diode 8 to measure the desired fluorescence signal. A collecting/calumniating lens 11 is configured to collect the fluorescence signal from cells/particles flowing through the microcapillary 31. A bandpass optical filter 13 intermediate diode 14 and mirror 10 can filter out all light other than beam 9. This in turn enables diode 14 to measure optical transmittance (i.e., extinction) of the beam 9 and allow measurement of the size of particles as they flow through microcapillary 31.

The combination of steering assembly 1 and mirror 10 is further configured to enable positioning of the laser 2 relative to the microcapillary 31 based on feedback from PIN diode 14 to enable interrogation of the microcapillary. Once tip assembly 4 is properly positioned within the housing 21, a plunger pin 5 biased by a spring 6 engages O-ring 34 so that a vacuum pump 17 configured to couple with the O-ring can apply vacuum pressure to suction aperture 41. This vacuum pressure, in turn, is effective to draw an amount of fluid through entry aperture 23 into input channel 37, microcapillary 31 and known-volume channel 33. A vacuum reservoir 20 can act to smooth out the vacuum pressure delivered to the tip assembly 4.

First and second sensor elements, such as photointerrupters 15a, 15b, which may be integrated chips that both transmit and receive light, are disposed within the housing 21. First photointerrupter 15a is positioned to illuminate and detect the fluid as it reaches first prism 35a, and second photointerrupter 15b is positioned to illuminate and detect flow of the fluid as it reaches second prism 35b. This functionality allows digital board 19 to determine when the fluid flow has fully traversed the known-volume channel 33 and, consequently, when such a known volume has traversed through microcapillary 31 and been interrogated. A display device 18, which may be a touch LCD, carried by the housing 21 is operable to present a visual image representative of particle interrogation data resulting from interrogation of the fluid flowing through microcapillary 31.

An embodiment includes a high quality, glass capillary tube incorporated into a plastic housing to create a high performance consumable flow cell. This embodiment allows multiple tests to be run in each consumable, and for the user to recollect a purified or precious sample from the cartridge reservoir following analysis. In addition to the capillary, each consumable may have three optical detection areas (an embodiment may have only two optical detection areas) to determine the arrival/presence of the sample being tested. The three detectors are used for Start, Stop, and Reservoir Full. The volume within the fluid channel between the Start and Stop detectors is used to calculate the volumetric particle count.

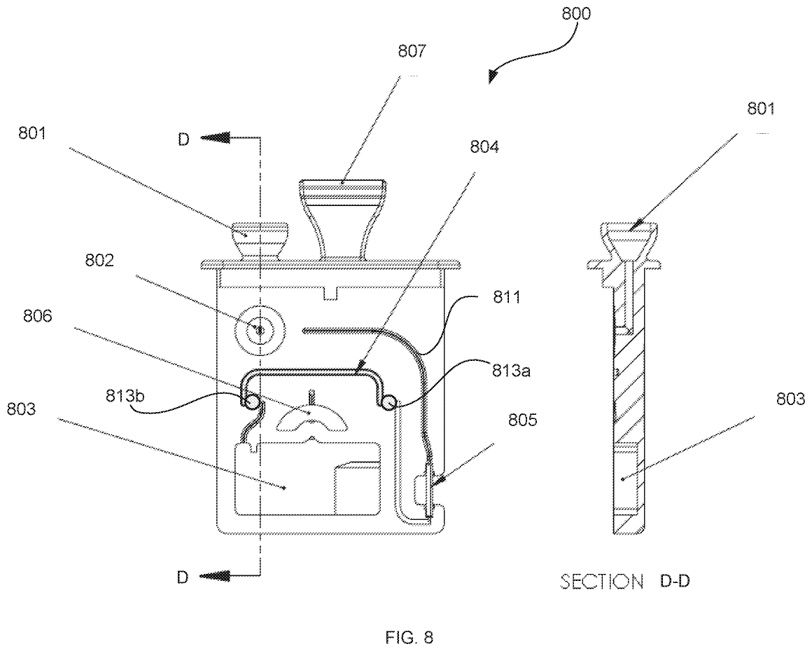

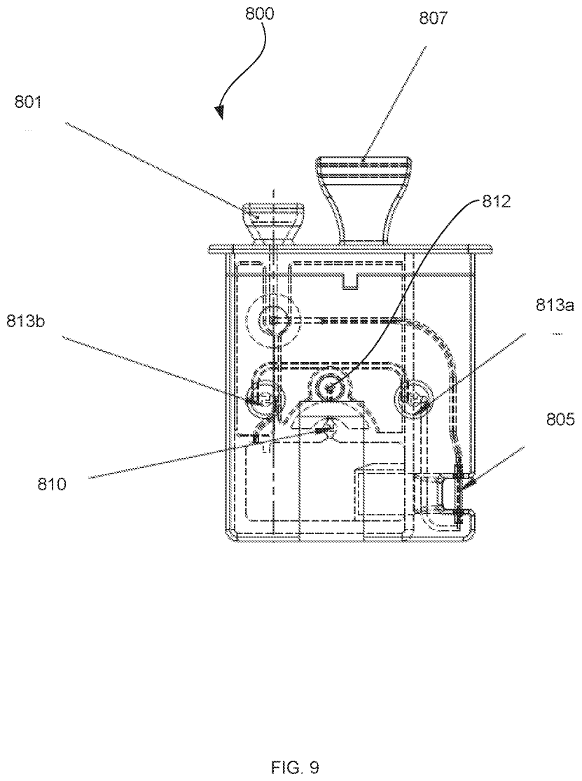

Referring to FIGS. 8 and 9, shown is an alternative embodiment consumable flow cell 800 similar in purpose and functionality to tip assembly 4 discussed above herein. FIG. 8 illustrates front-plan and cross-sectional views of the cell 800. In the illustrated embodiment, cell 800 includes a top-loading reservoir 801 into which a user may pipette one or more samples prior to beginning testing and a mesh filter 802 functioning to prevent large particles in the samples from clogging downstream elements.

Cell 800 has an input channel 811 and a known-volume channel 804 of predetermined known volume disposed therein. Each channel 811, 804 is configured to permit fluid flow therethrough. Reservoir 801 fluidly couples the input channel 811 to ambient and is configured to provide the fluid to the input channel upon the application of suction to cell 800. Cell 800 includes a suction aperture 812 fluidly coupling the known-volume channel 804 to ambient. Suction aperture 812 is operable to create a vacuum seal between cell 800 and an interrogation apparatus, as will be discussed in greater detail herein below. Cell 800 further includes an insertion/removal tab 807 configured to allow a user to insert and remove the cell with respect to the interrogation apparatus.

In the illustrated embodiment, a microcapillary 805 transmits fluid from one segment of input channel 811 to another segment of input channel. Microcapillary 805 permits interrogation of particles carried by the fluid passing therethrough by a sensor device external to cell 800, as will be discussed in greater detail herein below. A waste reservoir 803 is able to hold the contents of multiple discrete fluid samples that have been subject to interrogation via microcapillary 805.

Cell 800 further includes first and second sensor apertures (not shown). Sensor elements, such as first and second prisms 813a, 813b that refract light when wetted by the fluid, are respectively positioned in the first and second sensor apertures and in the fluid stream to permit detection of flow of the fluid by at least one sensor device external to the cell 800, as will be discussed in greater detail herein below. The first prism 813a is positioned to permit detection of flow of the fluid at an upstream portion (i.e., “start” position as discussed above) of the known-volume channel 804, and the second prism 813b is positioned to permit detection of flow of the fluid at a downstream portion (i.e., “stop” position as discussed above) of the known-volume channel. An overflow reservoir 806 functions to prevent fluid from leaving the tip cell 800 after a test is complete. A reservoir full detector portion 810 allows visual verification that the overflow reservoir 806 is at full capacity.

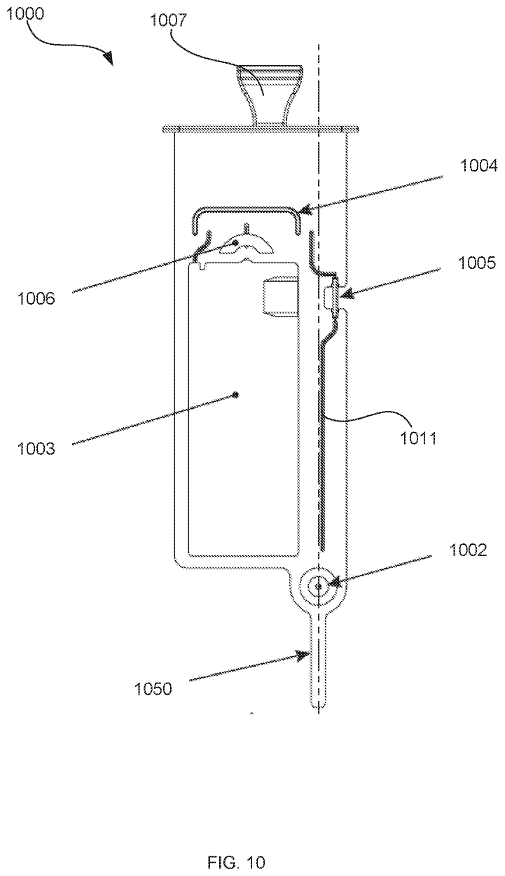

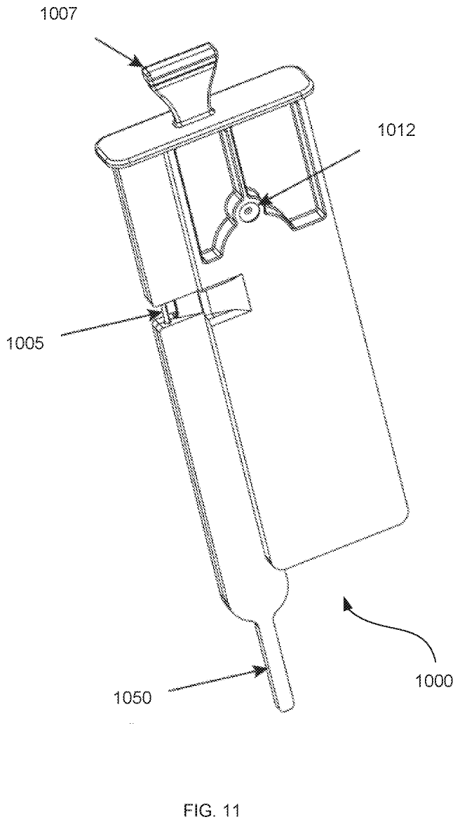

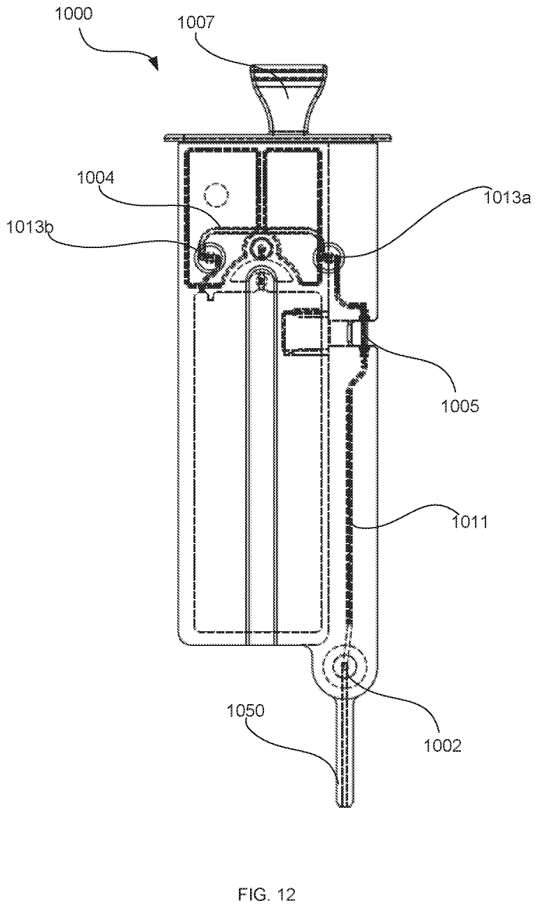

Referring to FIGS. 10-12, shown is an alternative embodiment pipette-loading consumable flow cell 1000. Cell 100 has all of the same features as the cell 800 except top-loading reservoir 801 and is likewise similar in purpose and functionality to tip assembly 4 discussed above herein. Rather, cell 1000 includes a pipette tip 1050 into which a user may draw one or more samples prior to beginning testing and a mesh filter 1002 functioning to prevent large particles in the samples from clogging downstream elements.

Cell 1000 has an input channel 1011 and a known-volume channel 1004 of predetermined known volume disposed therein. Each channel 1011, 1004 is configured to permit fluid flow therethrough. Tip 1050 fluidly couples the input channel 1011 to ambient and is configured to provide the fluid to the input channel upon the application of suction to cell 1000. Cell 1000 includes a suction aperture 1012 fluidly coupling the known-volume channel 1004 to ambient. Suction aperture 1012 is operable to create a vacuum seal between cell 1000 and an interrogation apparatus, as will be discussed in greater detail herein below. Cell 1000 further includes an insertion/removal tab 1007 configured to allow a user to insert and remove the cell with respect to the interrogation apparatus.

In the illustrated embodiment, a microcapillary 1005 transmits fluid from one segment of input channel 1011 to another segment of input channel. Microcapillary 1005 permits interrogation of particles carried by the fluid passing therethrough by a sensor device external to cell 1000, as will be discussed in greater detail herein below. A waste reservoir 1003 is able to hold the contents of multiple discrete fluid samples that have been subject to interrogation via microcapillary 1005.

Cell 1000 further includes first and second sensor apertures (not shown). Sensor elements, such as first and second prisms 1013a, 1013b that refract light when wetted by the fluid, are respectively positioned in the first and second sensor apertures and in the fluid stream to permit detection of flow of the fluid by at least one sensor device external to the cell 1000, as will be discussed in greater detail herein below. The first prism 1013a is positioned to permit detection of flow of the fluid at an upstream portion (i.e., “start” position as discussed above) of the known-volume channel 1004, and the second prism 1013b is positioned to permit detection of flow of the fluid at a downstream portion (i.e., “stop” position as discussed above) of the known-volume channel. An overflow reservoir 1006 functions to prevent fluid from leaving the tip cell 1000 after a test is complete.

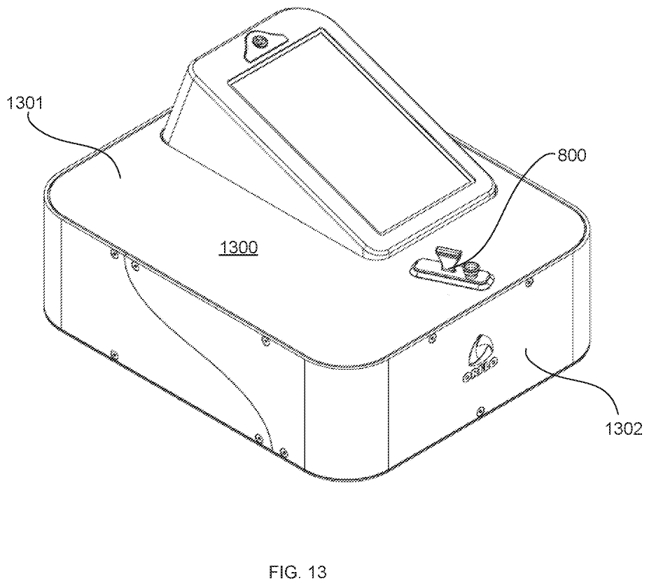

FIG. 13 is an isometric view of a fully integrated bench top system 1300 containing everything needed to run and analyze flow cytometry experiments as discussed above herein and to purify cell samples such as those associated with cell 800. This includes all of the excitation laser(s), cell ablation lasers, optics, photo detectors, alignment mechanisms/motors, vacuum pumps, computer processors, a battery, and a touch sensitive display. Cell 800 can be loaded for analysis on a top surface 1301, as shown, or loaded into a slot (now shown) in the side surface 1302. Additionally, system 1300 may have a cavity (not shown) inside surface 1302 into which a tray of samples may be placed from which cell 1000 can withdraw fluid to be tested.

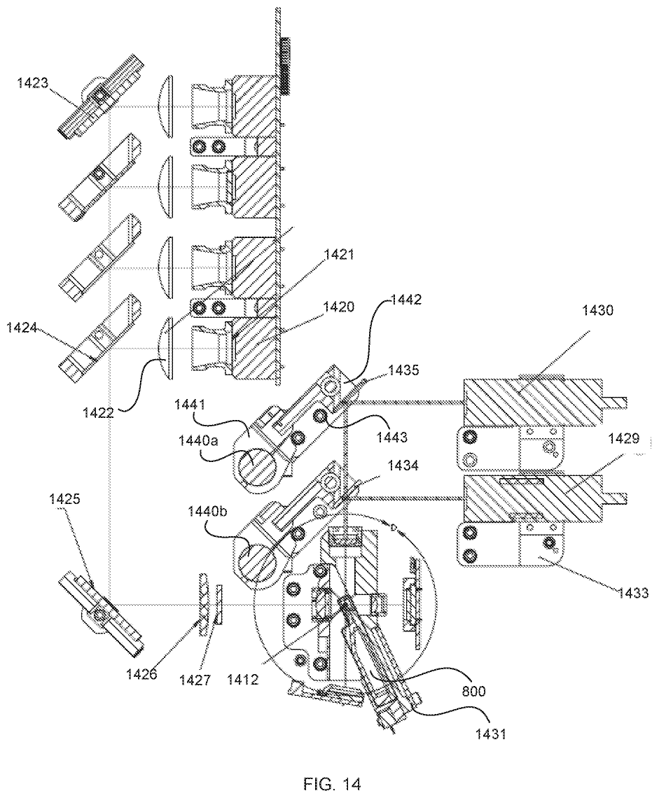

FIG. 14 is a top plan partial cross-sectional view of the optics layout of and internal to system 1300 showing two lasers 1429, 1430 with distinct (and different) wavelengths for particle/cell excitation. The lasers reflect off one of two mirrors 1434, 1435 each prior to passing through a focusing lens 1511 on the way to the consumable flow cell 800 (or 1000). Each of these mirrors 1434, 1435 is used, with the feedback from an optical detector 1416, to align the lasers 1429, 1430 (one at a time) to the capillary tube 1412 and incoming laser light 1410 within the flow cell 800. This alignment is both optionally advantageous and unique to flow cytometers according to one or more embodiments. It allows consumable flow cells to be inserted and used reliably as the inner diameters of the capillaries are very small (i.e., on the order of a biological cell, or 30 to 100 μm in diameter (or other shape such as square)). An alternative embodiment can also use just one excitation laser.

System 1300 further has laser-steering assemblies that include an eccentric cam 1440a, 1440b, DC gear motor with encoders 1441, pivoting arm 1442 that holds a mirror and runs on the cam, and steering assembly base 1443 that holds the motor and cam. A laser/optics pathway includes photodetector (such as a photomultiplier tube) 1420, optical bandpass filter 1421, focusing lens 1422, mirror 1423, dichroic mirror 1424, mirror 1425, collection/focusing lens 1426, optical long pass filter 1427, flow cell housing 1431, which holds the consumable flow cell 800 in position relative to the incoming laser light, a transmittance photodetector (PIN diode), and two collection lenses (one for primary fluorescence and one for side scatter), and an adjustable laser mount 1433.

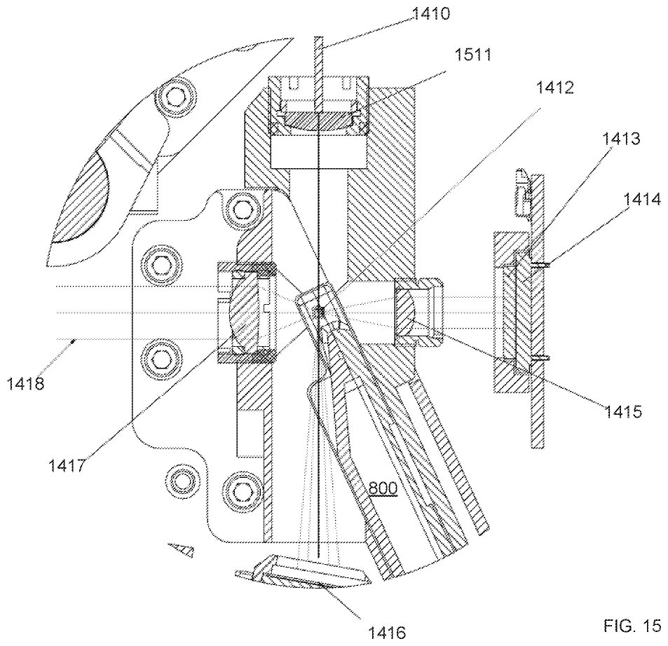

As shown in FIG. 15, system 1300 further includes an optical band pass filter 1413 for primary laser wavelength, #14, primary laser light side scatter photodetector 1414, optical collection lens 1415 for side scatter detector, and optical collection lens 1417 for primary fluorescence detectors. Collected primary fluorescence light 1418 is then passed along to the optics pathway.

In addition, a system can be configured such that one of these two lasers 1429, 1430 is an excitation laser and the other is an ablation laser. Alternatively, the system can be configured such that the ablation laser is a stand-along module that can be plugged into the underside of the system (or not) at any point in time, thus transforming the flow cytometer into a cell analyzer/purification system.

To purify a cell sample, the user would simply run a control sample in the system to determine where to set the measured PMT event thresholds for cell ablation. Typically, cell populations are labeled with fluorescent markers to specifically indicate cells that are to be ablated or not ablated. Once the trigger thresholds are set in the system, a new cartridge would be placed in the system and the cells to be purified are pipetted into the cartridge. As cells run, substantially, single-file through the capillary tube, they are analyzed for the presence (or absence) of fluorescent markers. Depending on how the ablation triggers were set, a real-time decision is made for each cell and it it's either ablated (or not) instantaneously by the UV ablation laser. The entire analysis/ablation time scale is on the order of microseconds (or less). The purified sample would be collected from the cartridge once the entire sample had been processed.

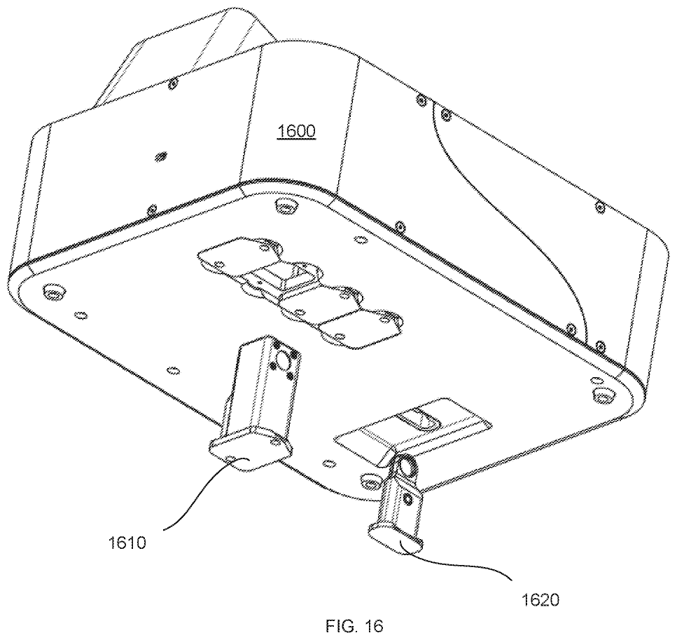

FIG. 16 is an underside isometric view of an alternative configuration of a bench top system 1600 showing the complete system but with the very expensive photo detectors (e.g., photomultiplier tubes (PMTs), avalanche photodiodes, PIN diodes, etc.) designed to be modular inserts. In this embodiment, the PMTs are packaged into individual modules that can be purchased separately from the system and inserted at any time by the user. In FIG. 16, shown is the PMT module 1610 and an optical filter element 1620 for the PIN diode that measures either primary fluorescence or side-scatter.

This has significant market advantages over competitive systems as it allows the base system to be sold at a very affordable price. System owners can then upgrade the performance of their system as finances allow. An embodiment allows up to four PMT modules to be added, but this concept can be used to build systems with any number of PMTs.

In addition, it is also advantageous to make the optical filter for the photo detector (PIN diode is currently preferred) that is normal to the excitation laser(s) to be modular. This allows the system to be configured to measure primary fluorescence, very inexpensively, when the system is sold with no PMT modules. Once the owner upgrades the system with one or more PMT modules, they can replace the normal primary fluorescence optical filter with a filter that allows excitation laser light side-scatter measurements with the same PIN diode.

In addition, the base system can also be designed such that the relatively expensive excitation laser(s) and/or cell ablation (aka, purification) lasers are also modular. The cell ablation laser is relatively expensive (multiple thousands of USD). By making this laser modular, the user can purchase a fully capable flow cytometer/cell analyzer, and then later purchase the expensive ablation laser and simply insert the laser into the system. This effectively transforms the system into a fully functional cell purification (aka, “sorting”) system. Cell ablation lasers are typically in the UV wavelength range (˜300 nm to ˜400 nm) and are relatively high power (>0.25 W) compared to excitation lasers for analysis.

An embodiment includes a capillary flow system that uses a capillary only once for each test. To do this, an embodiment holds multiple capillary tubes in one assembly (e.g., 16 tubes) and can be dropped into the system when the previous carousel is used up. An embodiment uses beam steering technology according to an embodiment to align the laser to each capillary tube prior to running a test. The beam steering technology includes a mirror mounted on an arm with a mechanical pivot. The mirror/arm assembly is biased against an eccentric cam that is attached to an electric motor using a mechanical spring. A computing device controls the motor to rotate the cam and thereby oscillate the mirror/arm assembly. The mirror may be placed at 45 degrees to cause the laser light to be angled 90 degrees (from the origin) plus or minus a few degrees by moving the mirror/arm assembly. The laser is turned on and steered back and forth past the capillary tube. An embodiment uses feedback from a PIN diode to determine when the laser is aligned perfectly to the capillary. A second 16-up sample carousel can hold 16 different sample vials. The two carousels can work in concert to draw biological samples, one test at a time, from one vial at a time. An embodiment may also be used in conjunction with multi-well sample plates, such as, for example, 96 well plates.

In a first embodiment, the sample carousel can rotate and move up and down. Prior to running a test, the sample carousel can move up so that the capillary makes contact with the fluid containing cells. etc. Fluid can be drawn into the system using a metered vacuum. Volumetric counts (i.e., number of cells per volume) can be determined by measuring the arrival of the sample meniscus as it passes, in an embodiment, multiple (at least two) optical detectors as it is pulled along a clear tube. The laser can be used as the first optical detector.

Alternate embodiments can include a single sample vial holder. Alternate volumetric determination means can be the use of volumetric metered pumps and peristaltic pumps. Multiple capillary handling techniques are also possible such as a bandolier type arrangement or an individual capillary tube handling mechanism. Alternative laser alignment means can be to move the capillary into the center of the laser beam instead of steering or moving the laser.

While the preferred embodiment of the invention has been illustrated and described, as noted above, many changes can be made without departing from the spirit and scope of the invention. For example, and generally speaking, components of various embodiments can include a light source and photodetector for single particle fluorescence detection/analysis. Light source could be a laser, LED or other illuminating element. The photodetector could be a photomultiplier tube, PIN diode, avalanche photodiode, or other appropriate device. This same capillary consumable approach can also be configured for a bench top (or small handheld) system. In such an embodiment, the consumable would not be a tip assembly but a chip that the user would dispense the sample into using a traditional pipette (or other means). Virtually all other aspects of the embodiment described in preceding paragraphs would be the same or very similar. Additionally, an embodiment may employ a tip/cartridge that may include a “capillary tube” having a waste reservoir configured to hold the complete volume of the sample but having no “start” and “stop” detectors such as those discussed above herein. Such an embodiment would provide counts by having a user inform the system of the volume of the sample being tested. The system would then just detect and count every cell/particle contained in the sample to obtain volumetric counts. Other embodiments may do the analysis of the particles but not provide volumetric counts at all. Accordingly, the scope of the invention is not limited by the disclosure of the preferred embodiment. Instead, the invention should be determined entirely by reference to the claims that follow.

What is claimed is:

1. An apparatus, comprising:
a body having:
at least one channel disposed therein, the channel configured to permit fluid flow therethrough, a first portion of the at least one channel being configured to permit interrogation of particles carried by a fluid passing therethrough by a sensor device external to the body,
the body further comprising an entry aperture fluidly coupling the at least one channel to ambient and configured to receive the fluid into the at least one channel; and
first and second sensor elements, the first element positioned to permit detection of flow of the fluid upstream of a second portion of the at least one channel, the second element positioned to permit detection of flow of the fluid downstream of the second portion of the at least one channel.

2. The apparatus of claim 1, wherein the body further comprises a suction aperture disposed at an end of the at least one channel opposite the entry aperture, the suction aperture fluidly coupling the at least one channel to ambient.

3. The apparatus of claim 1. wherein the first portion comprises a translucent tube coupling a first segment of the at least one channel to a second segment of the at least one channel.

4. The apparatus of claim 1, wherein:
the body further comprises first and second sensor apertures; and
the first and second sensor elements are light-transmissive, positioned in fluid communication with the fluid, and respectively positioned in the first and second sensor apertures to permit detection of flow of the fluid by at least one sensor device external to the body.

5. A microfluidic interrogation apparatus, comprising:
a housing configured to receive therein a sampling device comprising at least one channel configured to permit fluid flow therethrough, a first portion of the at least one channel being configured to permit interrogation of particles carried by a fluid;
a source of suction configured to be coupled to the sampling device and operable to apply a reduced pressure to the sampling device effective to draw an amount of the fluid through at least the first portion of the at least one channel;
a microfluidic particle detector disposed within the housing and configured to interrogate the first portion; and
a microprocessor and an associated memory disposed within the housing and disposed operably in-circuit with the particle detector to receive particle-related data from the particle detector.

6. The apparatus of claim 5, wherein the housing is sized sufficiently small in both weight and enclosed volume as to permit a single person, by hand and without tools, to move the entirety of said apparatus from a first location to a second location.

7. The apparatus of claim 5, further comprising an alignment mechanism disposed within the housing and configured to position the first portion relative to the particle detector to enable interrogation of the first portion.

8. The apparatus of claim 7, wherein the alignment mechanism comprises at least one laser, at least one mirror and at least one optical detector.

9. The apparatus of claim 5, further comprising first and second sensor elements, the first element positioned to detect flow of the fluid upstream of a second portion of the at least one channel, the second element positioned to detect flow of the fluid downstream of the second portion of the at least one channel.

10. The apparatus of claim 5, further comprising a display device carried by the housing and disposed operably in-circuit with the microprocessor, the display device being operable to present a visual image representative of particle interrogation data resulting from microfluidic interrogation performed by the apparatus.

11. The apparatus of claim 5, wherein the particle detector comprises:
a laser;
a control surface configured to direct an illuminating beam emitted by the laser to the first portion; and
an optical detector positioned within a line of sight of the illuminated first portion.
